(19) United States
(12) Patent Application Publication
(10) Pub. No.: US 2026/0299111 A1
(43) Pub. Date: Oct. 1, 2026

(54) PROCEDURES FOR WIDEBAND SENSING VIA SUCCESSIVE-IN-TIME NARROWBAND TRANSMISSIONS

(71) Applicant: QUALCOMM Incorporated, San Diego, CA (US)

(72) Inventors: Stelios STEFANATOS, San Diego, CA (US); Shijun WU, San Diego, CA (US); Arthur GUBESKYS, San Diego, CA (US)

(21) Appl. No.: 19/479,246

(22) PCT Filed: May 13, 2024
(86) PCT No.: PCT/US2024/029129

§ 371 Date: Oct. 27, 2025

(30) Foreign Application Priority Data
Jul. 3, 2023 (GR) 20230100538

(51) Int. Cl. G01S 13/58; G01S 13/02

(52) U.S. Cl. CPC G01S 13/583; G01S 13/0209

(57) ABSTRACT

A method for wireless communication at a user equipment (UE) and related apparatus are provided. In the method, the UE transmits a first sensing signal having a first duration and at a first frequency band and obtains a Doppler estimation of a target object based on a reflection of the first sensing signal. The UE then transmits a second sensing signal having a second duration shorter than the first duration and at a second frequency band different than the first frequency band and performs a successive-in-time sensing, based on the Doppler estimation and a combination of the first reflection of the first sensing signal and a second reflection of the second sensing signal to obtain sensing information for the target object.

### CROSS-REFERENCE TO RELATED APPLICATION

This application claims the benefit of Greek patent application No. 20230100538, entitled “PROCEDURES FOR WIDEBAND SENSING VIA SUCCESSIVE-IN-TIME NARROWBAND TRANSMISSIONS” and filed on Jul. 3, 2023, which is expressly incorporated by reference herein in its entirety.

### TECHNICAL FIELD

The present disclosure relates generally to communication systems, and more particularly, to procedures for wideband sensing via successive-in-time narrowband transmissions in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to transmit a first sensing signal having a first duration and at a first frequency band; obtain a Doppler estimation of a target object based on a reflection of the first sensing signal; transmit a second sensing signal having a second duration shorter than the first duration and at a second frequency band different than the first frequency band; and perform a successive-in-time sensing, based on the Doppler estimation and a combination of the first reflection of the first sensing signal and a second reflection of the second sensing signal to obtain sensing information for the target object.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to receive, from a UE, a resource request for a successive-in-time sensing on a target object to obtain sensing information of the target object; allocate, for the UE, first resource for a first sensing signal, the first sensing signal having a first duration and at a first frequency band; and allocate, for the UE, second resource for a second sensing signal in combination with the first sensing signal, the second sensing signal having a second duration shorter than the first duration and at a second frequency band different than the first frequency band.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of sensing signal transmission and reflection.

FIG. 4B is a diagram illustrating an example of sensing transmission.

FIG. 5 is a diagram illustrating an example of stitching multiple narrowband transmissions to achieve a wideband transmission.

FIG. 6A is a diagram illustrating an example of successive-in-time transmissions in accordance with various aspects of the present disclosure.

FIG. 6B is a diagram illustrating an example of successive-in-time transmissions in accordance with various aspects of the present disclosure.

FIG. 7 is a diagram illustrating an example of successive-in-time transmissions in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a network entity in accordance with various aspects of the present disclosure.

FIG. 12 is a flowchart illustrating methods of wireless communication at a network entity in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

High resolution sensing may be associated with wideband transmissions that, for certain applications, reach up to a few GHz. These applications often include signal bandwidths larger than those specified for wireless communication traffic, such as for New Radio (NR) communication traffic. However, achieving wideband transmissions becomes challenging when the UE is restricted by a maximum bandwidth capability or when network conditions, such as congestion, limit the allocation of wideband component carriers (CCs). Additionally, moving targets introduce a Doppler effect that can compromise the phase coherence of multiple successive narrowband transmissions, further complicating the goal of effective wideband sensing. Example aspects presented herein address these challenges by introducing a method of wideband sensing using multiple successive-in-time narrowband transmissions.

Various aspects relate generally to wireless sensing transmissions. Some aspects more specifically relate to procedures for wideband sensing via successive-in-time narrowband transmissions in association with wireless communication. In some examples, a UE may transmit a first sensing signal having a first duration and at a first frequency band, and obtain a Doppler estimation of a target object based on a reflection of the first sensing signal. The UE may further transmit a second sensing signal having a second duration shorter than the first duration and at a second frequency band different than the first frequency band. In some examples, the second sensing signal may be transmitted after the first sensing signal. In some examples, the second sensing signal may be transmitted before the first sensing signal. The UE may perform a successive-in-time sensing based on the Doppler estimation and a combination of the first reflection of the first sensing signal and a second reflection of the second sensing signal to obtain sensing information for the target object as if a single wideband sensing transmission was performed.

Particular aspects of the subject matter described in this disclosure can be implemented to realize one or more of the following potential advantages. In some examples, by using multiple successive-in-time narrowband transmissions to achieve effective wideband transmission, the described techniques can be used to achieve better sensing results compared to existing methods, particularly in scenarios where a single wideband transmission is unattainable (e.g., when a UE is limited by maximum bandwidth or when network conditions restrict wideband transmission). In some aspects, by coherently combining multiple narrowband transmissions, the described techniques increase the effective sensing bandwidth, resulting in improved range resolution and enhanced sensing accuracy. In some aspects, by allowing the UE to indicate the Coherent Processing Interval (CPI) and the number of sensing symbols, the described techniques enhance the network's ability to optimally allocate resources, leading to improved network efficiency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

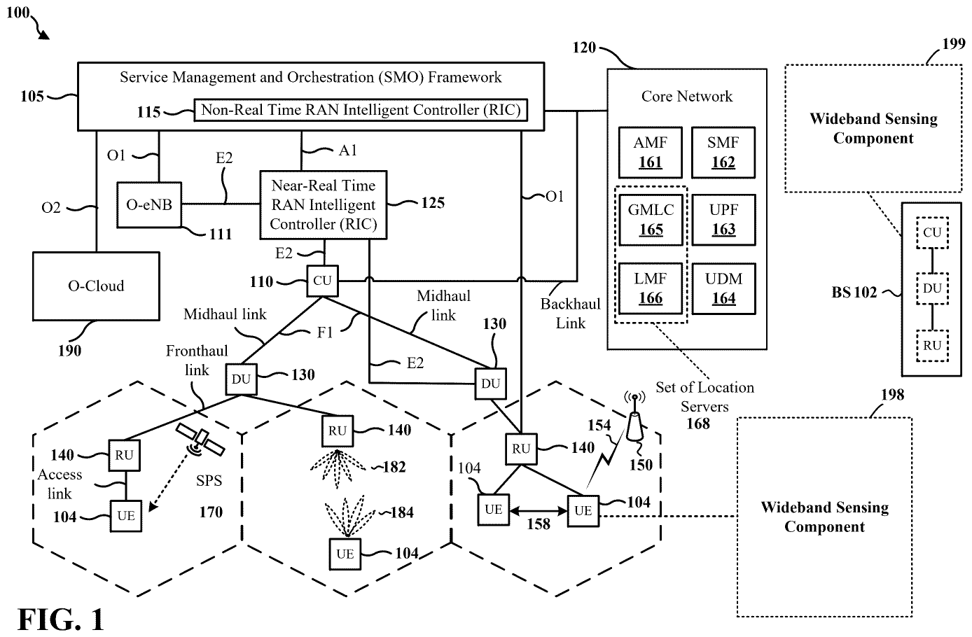

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a wideband sensing component 198. The wideband sensing component 198 may be configured to transmit a first sensing signal having a first duration and at a first frequency band; obtain a Doppler estimation of a target object based on a reflection of the first sensing signal; transmit a second sensing signal having a second duration shorter than the first duration and at a second frequency band different than the first frequency band; and perform a successive-in-time sensing based on the Doppler estimation and a combination of the first reflection of the first sensing signal and a second reflection of the second sensing signal to obtain sensing information for the target object. In certain aspects, the base station 102 may include a wideband sensing component 199. The wideband sensing component 199 may be configured to receive, from a UE, a resource request for a successive-in-time sensing on a target object to obtain sensing information of the target object; allocate, for the UE, first resource for a first sensing signal, the first sensing signal having a first duration and at a first frequency band; and allocate, for the UE, second resource for a second sensing signal in combination with the first sensing signal, the second sensing signal having a second duration shorter than the first duration and at a second frequency band different than the first frequency band. Although the following description may be focused on 5G NR, the concepts described herein may be applicable to other similar areas, such as LTE, LTE-A, CDMA, GSM, and other wireless technologies.

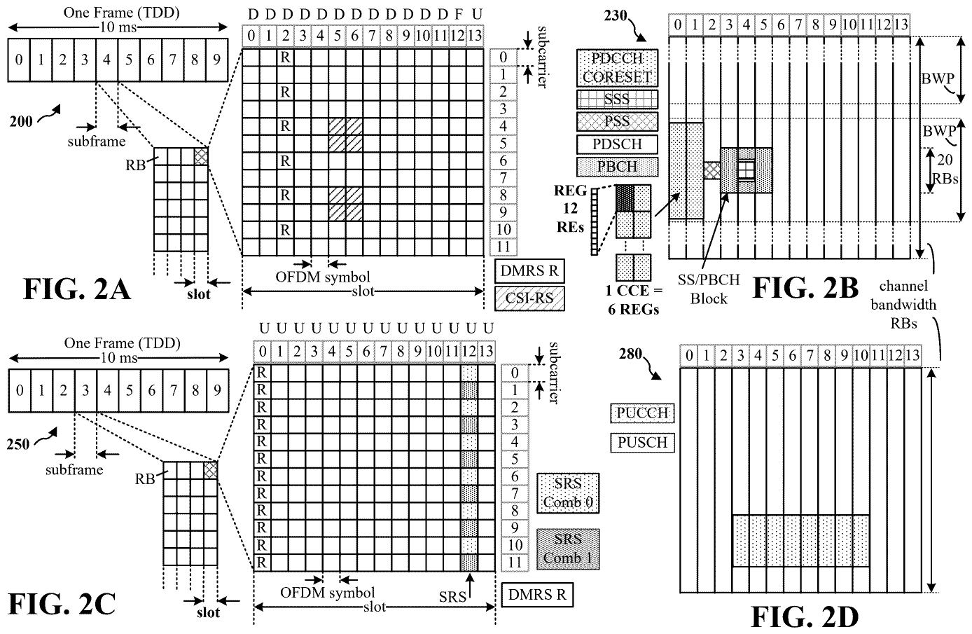

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Af = 2^{μ} · 15[KHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

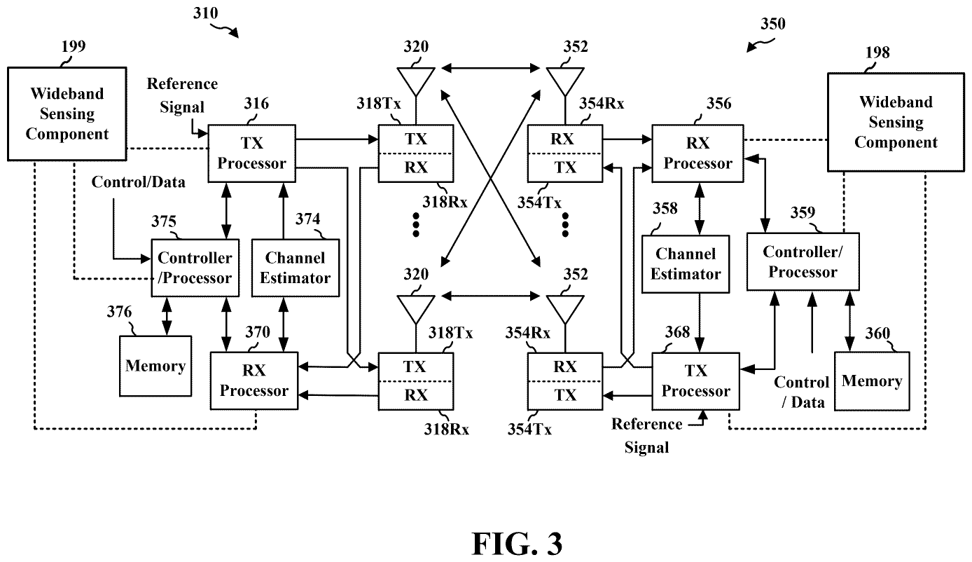

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the wideband sensing component 198 of FIG. 1.

At least one of the TX processor 316, the RX processor 370, and the controller/processor 375 may be configured to perform aspects in connection with the wideband sensing component 199 of FIG. 1.

Example aspects provide techniques for effectively achieving wideband transmission by combining or “stitching” multiple successive-in-time narrowband transmissions. The proposed techniques address the main issue of maintaining the phase coherence throughout the successive-in-time narrowband transmissions. In some aspects, the whole successive-in-time narrowband transmissions are separated into two parts. The first part will be used for Doppler estimation, and the second part will be used for sweeping the rest of the wide bandwidth. Phase compensation is applied to all transmissions based on the Doppler estimation obtained in the first part, and the transmissions are then coherently combined for an effective wideband transmission of the second part.

High resolution (in range) sensing may be based on wideband transmissions with a frequency band of up to several GHz for certain applications. Network deployments, particularly in millimeter-wave (mmWave) technology, may be configured to have narrowband channels (e.g., CCs up to 100 MHz), indicating that wideband transmission is likely performed via carrier aggregation (CA).

However, under congested network conditions, allocating multiple CCs simultaneously to the same UE for sensing tasks may be challenging. Furthermore, some UEs might not inherently support such wideband transmissions. In these instances, effective wideband sensing transmission can be achieved by performing successive-in-time narrowband transmissions across multiple different frequency allocations. This operation necessitates consideration for phase changes across these transmissions.

A significant source of these phase changes can be attributed to Doppler shifts from the target(s), which suggests explicit tracking and compensation for these shifts. However, methods for compensating the Doppler shifts might lead to a sequence of long-duration narrowband transmissions that may potentially obstruct the UE from performing communication tasks or result in sensing inaccuracies due to significant changes in the target range within the total duration of all the narrowband transmissions. Example aspects presented herein provide solutions to account for and mitigate Doppler-induced phase shifts for successive-in-time narrowband sensing transmissions, while minimizing the total sensing transmission time when feasible.

A UE that supports wireless communication may also support RF sensing. UEs performing RF sensing may be a potential feature supported in wireless communication systems. In monostatic sensing, a UE may emit a probing signal or waveform and simultaneously operate its receiver to detect any signal “returns” that result from the reflection of the probing signal off of any targets present in the surrounding area. For each detected target, certain parameters of interest may be estimated. These parameters may include, for example, the range or distance of the target from the sensing UE, the velocity of the target relative to the sensing UE's velocity, and the angular position of the target relative to the sensing UE's heading. The primary objectives of this approach are to detect as many targets as possible with highly accurate estimates of target parameters and to distinguish between targets that are closely spaced in some or all of the aforementioned parameters, thereby achieving high resolution.

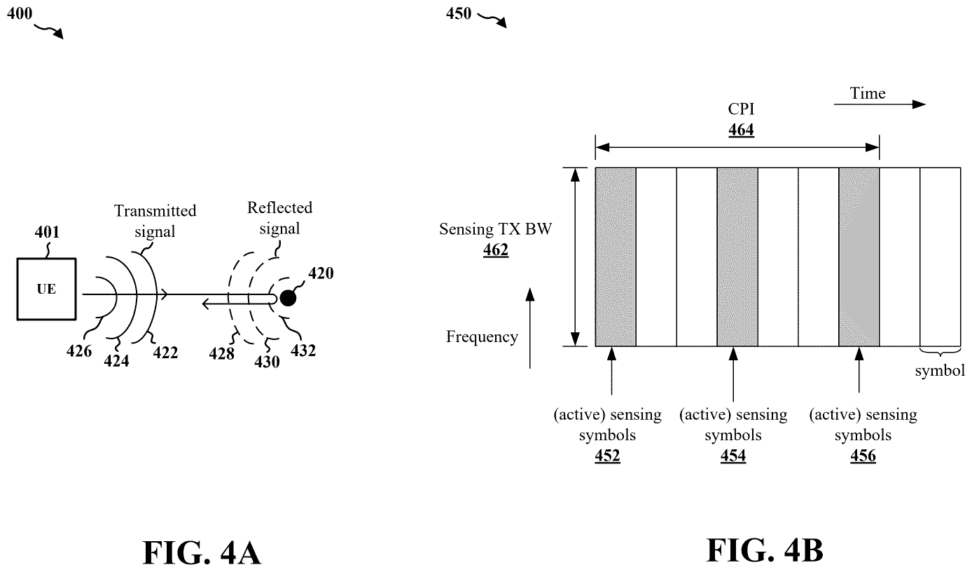

FIG. 4A is a diagram 400 illustrating an example of sensing signals generated from a UE 401 (e.g., as an example of a device that supports sensing) that may be used to measure information about an object 420 in an environment of the UE in accordance with various aspects of the present disclosure. The UE 401 may detect an object 420 by transmitting a set of sensing transmissions (e.g., 422, 424, 426). The sensing signals may reach an object 420 and reflect back to the UE 401, such as shown by the reflected signals (e.g., reflected chirp 428, 430, 432, which may correspond to the transmitted chirps 422, 424, 426, respectively). As there may be a distance between the UE 401 and the object 420 and/or it may take time for a transmitted signal to reach the object 420 and reflect back to the UE 401, a delay may exist between a transmitted signal and its corresponding reflected signal. The delay may be proportional to a range or distance between the UE 401 and the object 420 (e.g., the further the target, the larger the delay and vice versa). Thus, the UE 401 may be able to measure or estimate a distance between the UE 401 and the object 420 based on the delay, in some aspects. The probing signal for such sensing may possess certain properties. Firstly, it may have a large processing gain for detecting the presence of targets that generate weak returns due to a large range and/or low radar cross section (RCS). The processing gain may be proportional to factors such as transmission power, transmission and reception beamforming gains, and the number of symbols transmitted, which is known as the integration gain. Secondly, the probing signal may have a large bandwidth (BW) for achieving the range estimation with high resolution. Finally, the probing signal may have a large “coherent processing interval” (CPI) to ensure high-resolution velocity estimation.

FIG. 4B is a diagram 450 illustrating an example of sensing transmission. In FIG. 4B, a large BW 462 and a long CPI 464 may be used to facilitate high-resolution target estimation. The sensing signal may not necessarily contiguously occupy the allocated bandwidth and/or CPI. For example, a comb-type pattern may be employed in the frequency domain and/or the time domain. In the example of FIG. 4B, the sensing signal may be contiguous in BW 462, but may have a comb pattern (consisting of sensing symbols 452, 454, and 456) in the time domain. In some examples, the implementation of comb patterns in frequency and time might result in a reduction of the maximum detected range and velocity, respectively. However, such reductions may be deemed acceptable when the maximums range/velocity achieved with contiguous transmission in BW/time exceed the desired range of the sensing application. In the example of FIG. 4B, the 7-symbol CPI 464 may be covered by three sensing symbols (sensing symbols 452, 454, and 456), demonstrating a comb-3 pattern in time. This configuration illustrates that, despite the overall CPI being represented by seven symbols, three symbols are sufficient to provide the desired integration gain.

Sensing signal BW in applications such as automotive may range from approximately 200 MHz (for medium range resolution in long-range radars) to a few GHz (for high range resolution in short-range radars). These sensing BWs are larger than the BWs of wireless communication traffic, e.g., such as NR communication traffic. An operator may provide, e.g., grant or allocate, the bandwidth for wideband transmissions. However, there are instances where performing a wideband transmission over a single channel, such as a single component carrier (CC), may not be feasible. For example, a reduced capability UE may support transmissions up to a restricted maximum bandwidth (e.g., 100 MHz or 50 MHz), and may not support a wideband transmission over a single channel. As another example, when all the CCs supplied by the network are configured to operate with small bandwidths (e.g., the measurements of current millimeter-wave (mmWave) network deployments may suggest that operators deploy CCs of at most 100 MHz), a wideband transmission over a single channel may not be supported. In the first scenario, the capability may not be supported by the UE, and wideband transmission may not be possible.

However, in the second scenario, provided that the operator's narrowband CCs are contiguous, an “effective” wideband transmission may be achieved through an example approach described below. First, multiple concurrent narrowband transmissions may be performed over multiple CCs, and second, the “returns” of all CCs may be jointly processed or “stitched” via a coherent combination of symbols across frequency and time domains. However, this approach involves the network's capability to allocate multiple CCs to the same sensing UE simultaneously, which might prove challenging under congested conditions. Therefore, there are instances where the network may not be able to allocate the necessary CCs for a wideband sensing transmission.

In some scenarios, a wideband transmission may be achieved by combining, or “stitching,” multiple successive-in-time narrowband transmissions to generate an effective result resembling a single wideband transmission.

Two examples illustrate this technique's practical application. In the first example, a network may provide a grant to a UE consisting of multiple successive (i.e., non-concurrent) transmissions over multiple contiguous narrowband CCs. This example may be employed when the network cannot allocate all of the CCs simultaneously. In the second example, the network may provide a grant to a reduced-capability UE, also known as a redcap UE, consisting of multiple successive (i.e., non-concurrent) transmissions over multiple contiguous frequency allocations. These frequency allocations may be contained within one or more BWPs, and these BWPs may in turn be contained within one or more CCs.

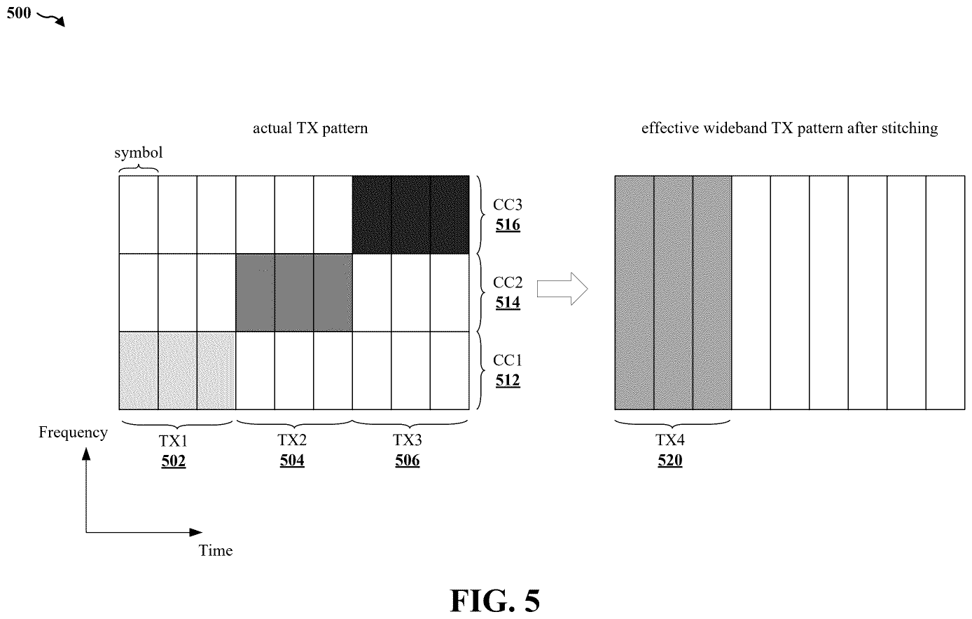

FIG. 5 is a diagram 500 illustrating an example of stitching multiple narrowband transmissions to effectively achieve a wideband transmission. In FIG. 5, a UE may be provided the grant for multiple successive transmissions over multiple contiguous narrowband CCs. These transmissions may include, for example, the first transmission (e.g., TX1 502) over the first CC (e.g., CC1 512), the second transmission (e.g., TX2 504) over the second CC (e.g., CC2 514), and the third transmission (e.g., TX3 506) over the third CC (e.g., CC3 516). These successive transmissions may be combined (or “stitched”) to generate an effective wideband transmission (e.g., TX4 520).

In scenarios where multiple successive narrowband transmissions are made across various frequency allocations and time instances, the phase coherence may be maintained throughout these transmissions to coherently combine these transmissions. Even with a UE implementation with its RF components capable of maintaining phase coherence, phase coherence may be lost if the targets sensed are moving during the sequences of successive narrow band transmissions. The moving targets may introduce a Doppler effect, which causes the return signal to experience phase variations over time. As a result, the successive-in-time transmissions each experience a different phase that should be accurately estimated and compensated for in order to coherently combine them.

If the successive sensing transmissions are not partially overlapping in time and frequency (e.g., in the case of the transmissions performed on a CC granularity), the target-induced Doppler shifts may be estimated to identify the phase shift between each transmission. Thus, all the narrowband transmissions may have a sufficiently long CPI to allow Doppler estimation (e.g., by capturing the movement of the target within the duration of each transmission). Then, the phase of each transmission may be compensated (e.g., “reversed”) independently, and the transmissions may then be “stitched” together for coherent processing.

However, with this approach the UE will be occupied with a sensing transmission that may be long (e.g., X times the time it would need with a single wideband transmission, where X is the number of successive narrowband transmissions), and the simultaneous operation of sensing and communication may not be possible (e.g., a low-cost UE implementation will most likely not support performing sensing and communication at the same time). Secondly, if the target velocity is large, it may cause considerable changes in the target range between the initial and final transmissions. Even with perfect phase compensation, the coherent combining gain may not be effective (ideally, the target range should remain constant across transmissions for the maximum combining gain). Furthermore, the resulting range estimate reflects an average of the range values throughout the total transmission interval, which may not provide the desired accuracy.

Example aspects presented herein provide methods to reduce or eliminate these adverse effects when performing wideband sensing using multiple, consecutive narrowband transmissions. These methods offer an improvement in the effective and efficient usage of UE, maintain phase coherence despite high target velocities, and help to ensure an accurate range estimate. Hence, the methods enhance the reliability and performance of sensing associated with wireless communication.

In some aspects, when the number of sensing symbols, denoted as Ni, for achieving the desired integration gain is smaller than the CPI, expressed in units of symbols as Nv, for obtaining the desired velocity resolution, a significant reduction in sensing duration may be achieved.

In some aspects, a long-duration transmission (i.e., the first transmission) corresponding to a CPI of Nv symbols may first be performed, based on which a high-resolution Doppler estimate of the target may be obtained. The subsequent transmissions may all have a shorter duration (e.g., Ni symbols) than the first transmission, following the integration gain specification. Doppler estimation may not be performed for these shorter transmissions under the assumption that the target velocity remains constant since the first transmission.

For phase compensation, all transmissions are adjusted based on the Doppler estimation from the first transmission (the “common” Doppler estimation), and the transmissions are then coherently combined. This results in an effective wideband transmission of duration equal to Ni symbols.

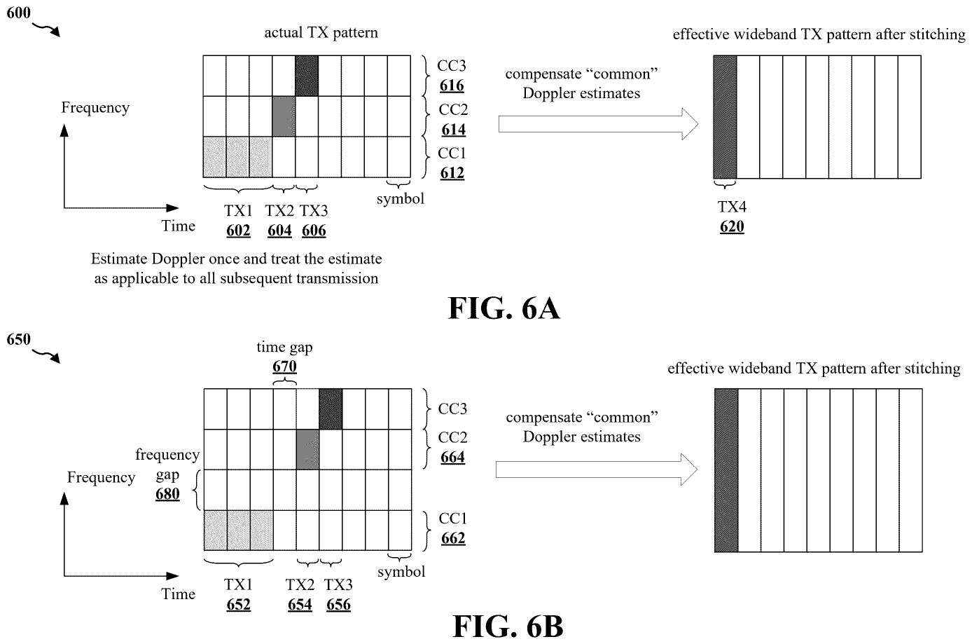

FIG. 6A is a diagram 600 illustrating an example of successive-in-time transmissions in accordance with various aspects of the present disclosure. FIG. 6B is a diagram 650 illustrating another example of successive-in-time transmissions in accordance with various aspects of the present disclosure. In the examples in FIGS. 6A and 6B, Ni=1 symbol and Nv=3 symbols. In FIG. 6A, the UE may first transmit the first transmission TX1 602 (over the first CC CC1 612) that has the duration of Nv symbols. Doppler estimation may be performed for the first transmission TX1 602. Following the first transmission TX1 602, the UE may transmit one or more successive transmissions, such as the second transmission TX2 604 (over the second CC CC2 614) and the third transmissions TX3 606 (over the third CC CC3 616). Each of these successive transmissions may have a shorter duration of Ni symbol than the first transmission TX1 602. Doppler estimation may not be performed on the successive transmissions (e.g., TX2 604 and TX3 606). Instead, the Doppler estimation for these transmissions (e.g., TX2 604 and TX3 606) may be assumed to be the same as that in the first transmission, and may be used to compensate for the Doppler-induced shift these transmissions (e.g., TX2 604 and TX3 606) experience. These successive transmissions may be combined (or “stitched”) with the first transmission to generate an effective wideband transmission (e.g., TX4 520). The example in FIG. 6B is similar with that in FIG. 6A, except that, in some examples, there may be a time gap 670 between the first transmission TX1 652 and the successive transmissions (e.g., TX2 654). The time gap 670 may be, for example, one symbol, as shown in FIG. 6B, or other values. In some examples, there may be a frequency gap 680 between the frequency band of the first transmission (e.g., CC1 662) and the frequency bandwidth of the successive transmissions (e.g., CC2 664). A comparison between a straightforward resource allocation (depicted in FIG. 5) and the proposed resource allocation (depicted in FIG. 6A and FIG. 6B) shows the effectiveness and efficiency of the proposed method. In the examples of FIG. 6A and FIG. 6B, the Doppler estimation is performed once for the first transmission (e.g., TX1 602, 652), but not for the successive transmissions (e.g., TX2 604, 654 and TX3 606, 656). On the other hand, in FIG. 5, the Doppler estimation may be performed for each transmission (e.g., TX1 502, TX2 504, and TX3 506). Additionally, the transmissions in FIG. 6A and FIG. 6B use a smaller number of symbols than the transmissions in FIG. 5. For example, two transmissions in FIG. 6A (e.g., TX1 602 and TX2 604) use four symbols, while two transmissions in FIG. 5 (e.g., TX1 502 and TX2 504) use six symbols. Hence, the proposed method offers a more efficient utilization of resources and a significant improvement in communication system performance.

In some aspects, the selection of parameters, such as Ni and Nv, may depend on the sensing specification of the UE and target velocities. The network may not be aware of the values of these parameters (e.g., the velocities), so it may not assign appropriate resources without any substantial information. On the other hand, the UE might discern these parameters (e.g., the velocities) based on previous detections of the target.

Hence, in some aspects, the UE, when requesting a grant for a sensing transmission, may indicate a desired CPI, as well as a desired number of sensing symbols for the sensing transmission. The CPI may be indicated in units of symbols, among other options.

In some aspects, even if there is a potential to reduce the total sensing duration of successive-in-time sensing transmissions, the resulting duration might still be too long, either blocking the UE from performing communication or not being short enough to assume the target range does not change significantly within it due to a large target velocity. In such cases, a UE might choose to avoid a wideband transmission, thereby sacrificing range resolution.

In some aspects, the UE may indicate whether it is willing to perform successive-in-time narrowband sensing transmissions. If it is willing, it may also provide the information for performing these transmissions, such as the desired CPI and the desired number of sensing symbols, among others.

In some aspects, in order to minimize the dynamic indication or signaling for performing successive-in-time narrowband sensing transmission, a UE may be assigned periodic resources for transmission with a fixed CPI (e.g., the first transmission) and a fixed number of symbols distributed in that CPI. These resources may be configured semi-statically (e.g., through RRC) or dynamically (e.g., through DCI). The CPI and the number of symbols may be indicated by the UE (e.g., via RRC or UCI) or they may be pre-configured. The periodicity may be indicated by the UE (e.g., via an RRC message or UCI) or it may also be pre-configured.

In some aspects, the UE might follow up such a transmission (e.g., the first transmission) with a request for one or more subsequent successive-in-time narrowband transmissions (over different frequency allocations covering a total bandwidth needed), indicating the duration of these transmissions in the number of consecutive symbols. In some aspects, the UE may further indicate the maximum time gap between these transmissions (e.g., the time gap between the first transmission and the subsequent successive-in-time transmission and the time gap between the successive transmissions themselves). This flexibility allows the UE to perform successive-in-time narrowband sensing transmissions as specified, based on the velocity reading from the periodically reoccurring resources.

In some aspects, the UE may request (e.g., via an RRC message or UCI) allocation for subsequent successive-in-time narrowband transmissions in every period until the expiration of a timer or until the UE indicates (e.g., via an RRC message or UCI) that these resources are no longer needed.

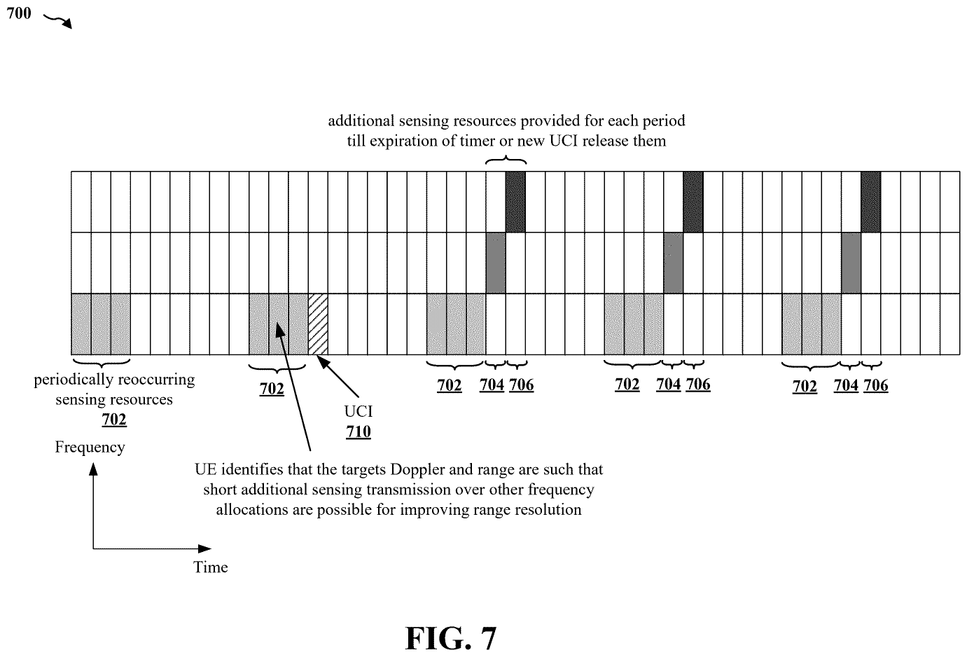

FIG. 7 is a diagram 700 illustrating an example of successive-in-time transmissions in accordance with various aspects of the present disclosure. In FIG. 7, the UE may be allocated periodically reoccurring sensing resources 702, and the UE may periodically transmit the first transmission using the reoccurring sensing resources 702. In some examples, if the UE identifies (e.g., based on the transmission on the sensing resources 702) that the targets Doppler and range are such that short additional sensing transmission over other frequency allocations are possible for improving the range resolution, the UE may transmit a request, via UCI 710, for example, to enable successive-in-time narrowband sensing transmission. In some examples, the UE may receive additional sensing resources (e.g., sensing resources 704, 706). These additional sensing resources (e.g., sensing resources 704, 706) may be provided for each period, and the UE may use these resources (e.g., sensing resources 704, 706) for successive-in-time transmissions. The UE may receive the additional sensing resources (e.g., sensing resources 704, 706) for a preset period of time (i.e., until a timer expires) or until the UE sends new UCI releasing these sensing resources.

In some aspects, it may be beneficial for the network to be informed of whether a UE is able to combine (or “stitch”) successive-in-time transmissions, so that the network may properly allocate resources among UEs that possess or lack this capability. In some aspects, the UE may report its capability related to maintaining phase coherence when switching frequency allocations. In some examples, the reported capability might also come with certain constraints. For instance, the UE might necessitate a minimum time gap between transmissions over different frequency allocations, or it could specify a maximum gap in frequency between these allocations. The UE's capability and its associated restrictions may provide critical information for the network to make an informed decision about resource allocation, thereby enhancing the efficiency of the wireless communication system.

In some aspects, to simplify the scheduling task and reduce signaling overhead, the resource scheduling may focus on a single CC, such as a Primary Cell (PCell), while providing the UE the autonomy to execute transmissions over other CCs according to its capabilities, sensing specification, and understanding of current target properties.

This approach provides the protection of the scheduled CC from interference through scheduling, allowing sensing UEs the option to perform wideband sensing, as desired. It bypasses having the scheduler solve combinatorial scheduling problems associated with allocating resources across multiple CCs.

While this method may introduce interference to non-scheduled CCs, such as Secondary Cells (SCell), the impact might be relatively insignificant, especially if, for instance, the sensing transmissions occur over UL resources (Time Division Duplex, TDD slots) and the sensing direction markedly differs from the network direction (e.g., the gNB direction), such as in an automotive scenario.

In some aspects, a UE scheduled for a sensing transmission over a CC may also be allowed to transmit over other CCs without the network explicitly allocating a grant for those resources. Potentially, the original grant could indicate some constraints the UE must adhere to. These constraints may include: which additional CCs it can transmit over, the maximum transmission power and/or power spectral density (PSD) mask for transmission over these CCs, the maximum delay after the original grant that the sensing TX over these CCs can be performed, and the condition that the sensing direction does not interfere with an UL direction, which may be indicated by a set of transmission configuration indicator (TCI) states (e.g., via the beam indices in the TCI states) in the grant.

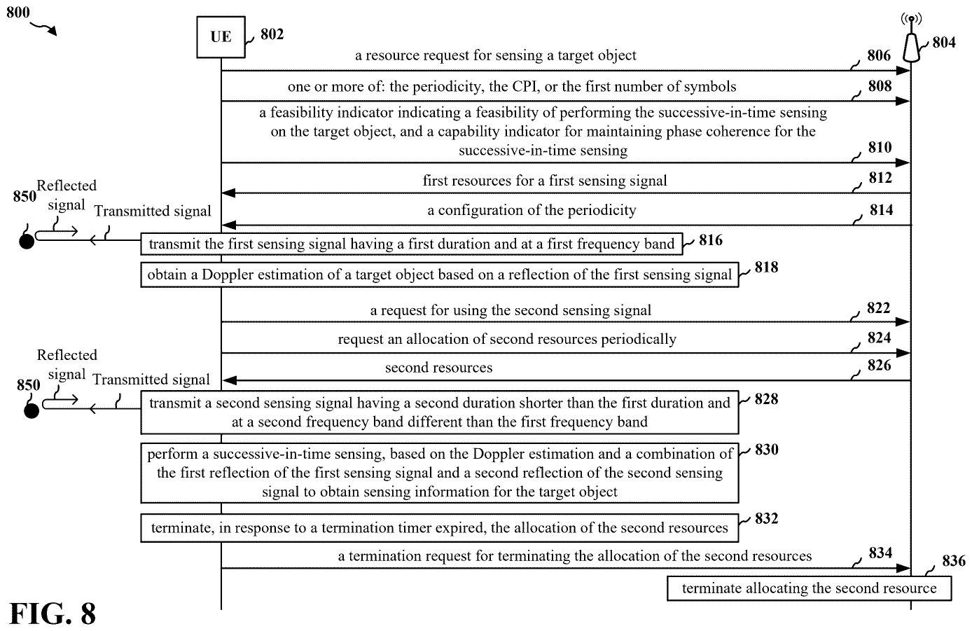

FIG. 8 is a call flow diagram 800 illustrating a method of wireless communication in accordance with various aspects of this present disclosure. Various aspects are described in connection with a UE 802 and a base station 804. The aspects may be performed by the UE 802 or the base station 804 in aggregation and/or by one or more components of a base station 804 (e.g., such as a CU 110, a DU 130, and/or an RU 140).

As shown in FIG. 8, a UE 802 may transmit, at 806, a resource request for sensing a target object to the base station 804.

At 808, the UE 802 may transmit one or more of: the periodicity, the CPI, or a first number of symbols to the base station 804. The first number of symbols may correspond to the duration of a first sensing signal for sensing the target object. In some examples, the transmission may be via an RRC message or UCI. In some examples, the CPI may be indicated in a unit of symbols.

At 810, the UE 802 may transmit a feasibility indicator to the base station 804. The feasibility indicator may indicate the UE's feasibility of performing the successive-in-time sensing on the target object. The feasibility may be based on an estimated total sensing time of the target object.

At 810, the UE 802 may also transmit a capability indicator for maintaining the phase coherence for the successive-in-time sensing to the base station 804. In some examples, the capability indicator may include one or more of: the minimum time gap between the first sensing signal and the second sensing signal, or the maximum gap between the first frequency band of the first sensing signal and the second frequency band of the second sensing signal. For example, referring to FIG. 6B, the capability indicator may include one or more of: the minimum time gap (e.g., the minimum value of the time gap 670) between the first sensing signal (e.g., TX1 652) and the second sensing signal (e.g., TX2 654), or the maximum gap (e.g., the maximum value of the frequency gap 680) between the first frequency band (e.g., CC1 662) of the first sensing signal and the second frequency band (e.g., CC2 664) of the second sensing signal.

In some aspects, at 812, the UE 802 may receive the allocation of first resources for the first sensing signal from the base station 804. For example, referring to FIG. 7, the UE may receive the allocation of first resources (e.g., 702) for the first sensing signal

In some aspects, at 814, the UE 802 may receive a configuration of a periodicity. For example, referring to FIG. 7, the UE may receive a configuration of the periodicity for the first resources (e.g., 702).

At 816, the UE 802 may transmit the first sensing signal for sensing the target object (e.g., 850). The first sensing signal may have the first duration at the first frequency band. For example, referring to FIG. 6A, the UE may transmit the first sensing signal (TX1 602) for sensing the target object. The first sensing signal (TX1 602) may have the first duration (e.g., three symbols) at the first frequency band (CC1 612).

At 818, the UE 802 may obtain a Doppler estimation of the target object based on a reflection of the first sensing signal. In some examples, the Doppler estimation of the target object may include an estimated velocity of the target object relative to the UE 802. For example, referring to FIG. 6A, the UE may obtain the Doppler estimation of the target object based on a reflection of the first sensing signal (TX1 602).

At 822, the UE 802 may transmit a request for using the second sensing signal to the base station 804. In some examples, the request for using the second sensing signal may further indicate one or more of: a duration (the second duration) for the second sensing signal, or the maximum time gap between the first sensing signal and the second sensing signal. In some examples, the transmission may be via an RRC message or UCI. For example, referring to FIG. 7, the UE may transmit, via the UCI 710, a request for using the second sensing signal to the base station.

In some aspects, at 824, the UE 802 may request, via an RRC message or UCI, the allocation of second resources periodically. For example, referring to FIG. 7, the UE may request the allocation of second resources (e.g., sensing resources 704, 706) periodically.

At 826, the UE 802 may receive the allocation of the second resources for the second sensing signal from the base station 804. For example, referring to FIG. 7, the UE may receive the allocation of the second resources (e.g., sensing resources 704, 706) for the second sensing signal.

At 828, the UE 802 may transmit the second sensing signal for sensing the target object. The second sensing signal may have the second duration shorter than the first duration and may be at a second frequency band different than the first frequency band. For example, referring to FIG. 6A, the UE may transmit the second sensing signal (e.g., TX2 604) for sensing the target object. The second sensing signal may have the second duration (e.g., one symbol) shorter than the first duration (e.g., three symbols) and may be at a second frequency band (e.g., CC2 614) different than the first frequency band (e.g., CC1 612).

At 830, the UE 802 may perform a successive-in-time sensing based on the Doppler estimation and the combination of the first reflection of the first sensing signal and a second reflection of the second sensing signal to obtain sensing information for the target object. In some examples, to perform the successive-in-time sensing on the target object, the UE 802 may apply a phase compensation to the first signal and the second signal based on the Doppler estimation to obtain phase-compensated signals; coherently combine the phase-compensated signals to obtain a wideband information having a duration of the second duration; and obtain the sensing information for the target object based on the wideband information. In some examples, the sensing information of the target object may include one or more of: the distance of the target object from the UE 802, the estimated velocity of the target object relative to the UE 802, or the angular position of the target object relative to the UE 802. For example, referring to FIG. 6A, the UE may perform a successive-in-time sensing based on the Doppler estimation and the combination of the first reflection of the first sensing signal (e.g., TX1 602) and a second reflection of the second sensing signal (e.g., TX2 604) to obtain sensing information for the target object.

In some aspects, at 832, the UE 802 may terminate, in response to a termination timer expired, the allocation of the second resources.

In some aspects, at 834, the UE 802 may indicate, to the base station 804, via an RRC message or UCI, a termination request for terminating the allocation of the second resources. Upon receiving the termination request from the UE 802, the base station 804 may terminate the allocation of the second resources at 836.

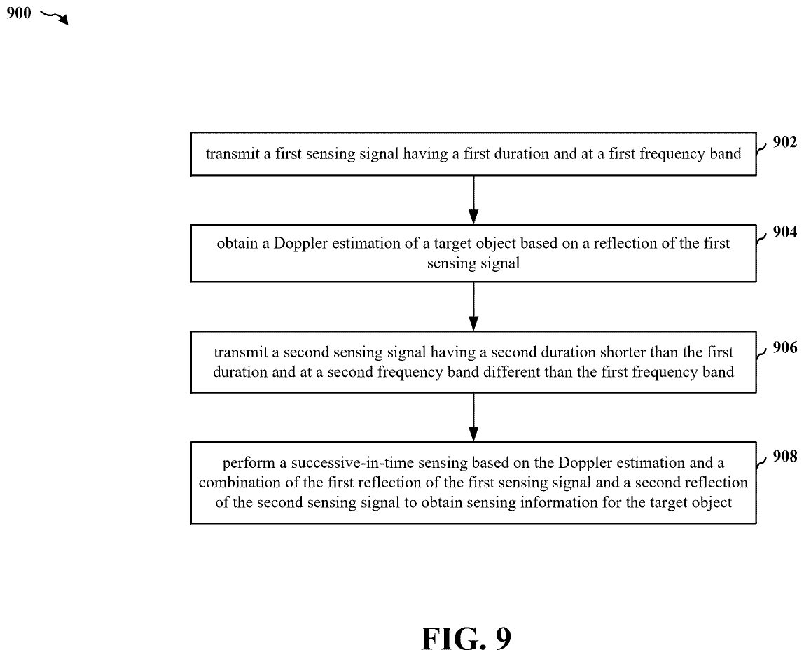

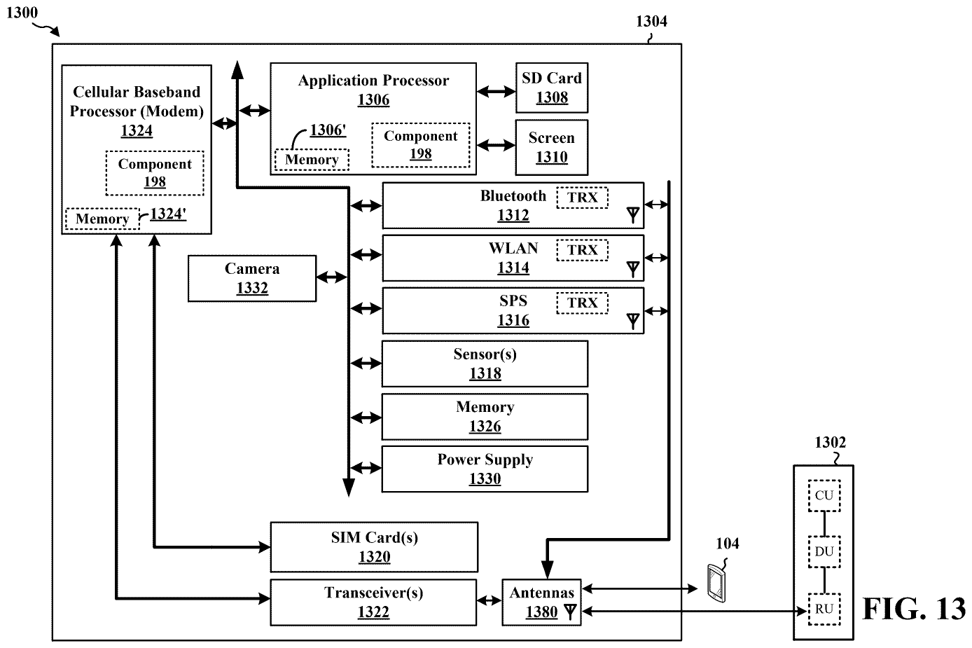

FIG. 9 is a flowchart 900 illustrating methods of wireless communication at a UE in accordance with various aspects of the present disclosure. The method may be performed by a UE. The UE may be the UE 104, 350, 802, or the apparatus 1304 in the hardware implementation of FIG. 13. The method offers a significant improvement in the effective and efficient usage of UE in RF sensing. The method maintains phase coherence despite high target velocities and ensures an accurate range estimate in RF sensing. Hence, it enhances the reliability and performance of wireless communication.

As shown in FIG. 9, at 902, the UE may transmit a first sensing signal. The first sensing signal may have the first duration and may be at the first frequency band. FIGS. 6A, 6B, 7, and 8 illustrate various aspects of the steps in connection with flowchart 900. For example, referring to FIG. 8, at 816, the UE 802 may transmit the first sensing signal for sensing the target object. Referring to FIG. 6A, the UE may transmit the first sensing signal (TX1 602) for sensing the target object. The first sensing signal (TX1 602) may have the first duration (e.g., three symbols) at the first frequency band (CC1 612). In some aspects, 902 may be performed by the wideband sensing component 198.

At 904, the UE may obtain a Doppler estimation of the target object based on a reflection of the first sensing signal. For example, referring to FIG. 8, at 818, the UE 802 may obtain a Doppler estimation of the target object based on a reflection of the first sensing signal. Referring to FIG. 6A, the UE may obtain the Doppler estimation of the target object based on a reflection of the first sensing signal (TX1 602). In some aspects, 904 may be performed by the wideband sensing component 198.

At 906, the UE may transmit the second sensing signal. The second sensing signal may have the second duration shorter than the first duration and have a second frequency band different than the first frequency band. For example, referring to FIG. 8, at 828, the UE 802 may transmit the second sensing signal for sensing the target object. Referring to FIG. 6A, the UE may transmit the second sensing signal (e.g., TX2 604) for sensing the target object. The second sensing signal may have the second duration (e.g., one symbol) shorter than the first duration (e.g., three symbols) and may be at a second frequency band (e.g., CC2 614) different than the first frequency band (e.g., CC1 612). In some aspects, 906 may be performed by the wideband sensing component 198.

At 908, the UE may perform a successive-in-time sensing based on the Doppler estimation and a combination of the first reflection of the first sensing signal and the second reflection of the second sensing signal to obtain sensing information for the target object. For example, referring to FIG. 8, at 830, the UE 802 may perform a successive-in-time sensing based on the Doppler estimation and the combination of the first reflection of the first sensing signal and a second reflection of the second sensing signal to obtain sensing information for the target object. In some aspects, 908 may be performed by the wideband sensing component 198.

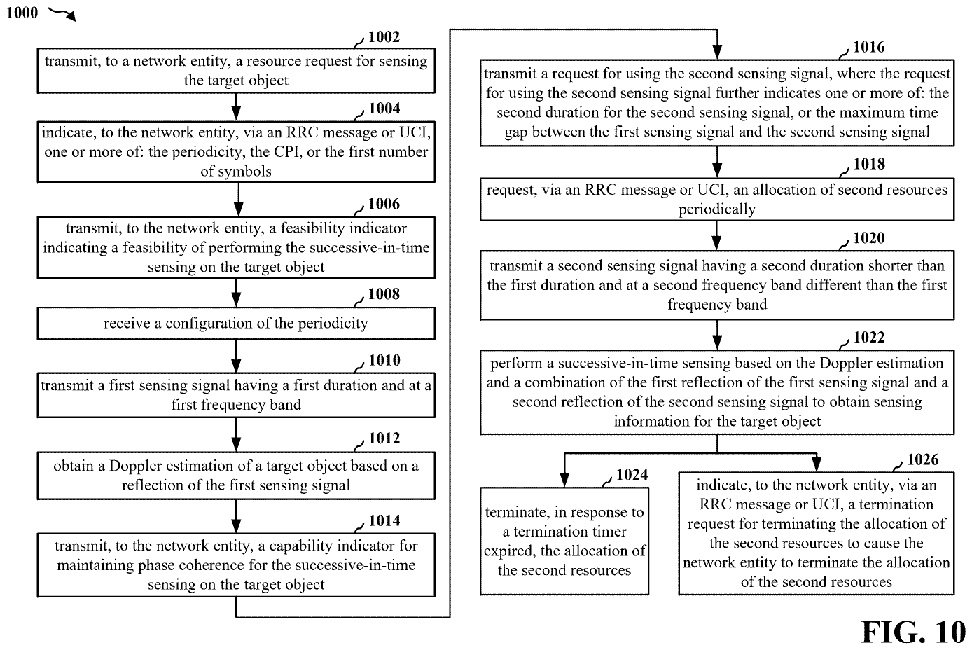

FIG. 10 is a flowchart 1000 illustrating methods of wireless communication at a UE in accordance with various aspects of the present disclosure. The method may be performed by a UE. The UE may be the UE 104, 350, 802, or the apparatus 1304 in the hardware implementation of FIG. 13. The method offers a significant improvement in the effective and efficient usage of UE in RF sensing. The method maintains phase coherence despite high target velocities and ensures an accurate range estimate in RF sensing. Hence, it enhances the reliability and performance of wireless communication.

As shown in FIG. 10, at 1010, the UE may transmit a first sensing signal. The first sensing signal may have the first duration and may be at the first frequency band. FIGS. 6A, 6B, 7, and 8 illustrate various aspects of the steps in connection with flowchart 1000. For example, referring to FIG. 8, at 816, the UE 802 may transmit the first sensing signal for sensing the target object. Referring to FIG. 6A, the UE may transmit the first sensing signal (TX1 602) for sensing the target object. The first sensing signal (TX1 602) may have the first duration (e.g., three symbols) at the first frequency band (CC1 612). In some aspects, 1010 may be performed by the wideband sensing component 198.

At 1012, the UE may obtain a Doppler estimation of the target object based on a reflection of the first sensing signal. For example, referring to FIG. 8, at 818, the UE 802 may obtain a Doppler estimation of the target object based on a reflection of the first sensing signal. Referring to FIG. 6A, the UE may obtain the Doppler estimation of the target object based on a reflection of the first sensing signal (TX1 602). In some aspects, 1012 may be performed by the wideband sensing component 198.

At 1020, the UE may transmit the second sensing signal. The second sensing signal may have the second duration shorter than the first duration and have a second frequency band different than the first frequency band. For example, referring to FIG. 8, at 828, the UE 802 may transmit the second sensing signal for sensing the target object. Referring to FIG. 6A, the UE may transmit the second sensing signal (e.g., TX2 604) for sensing the target object. The second sensing signal may have the second duration (e.g., one symbol) shorter than the first duration (e.g., three symbols) and may be at a second frequency band (e.g., CC2 614) different than the first frequency band (e.g., CC1 612). In some aspects, 1020 may be performed by the wideband sensing component 198.

At 1022, the UE may perform a successive-in-time sensing based on the Doppler estimation and a combination of the first reflection of the first sensing signal and the second reflection of the second sensing signal to obtain sensing information for the target object. For example, referring to FIG. 8, at 830, the UE 802 may perform a successive-in-time sensing based on the Doppler estimation and the combination of the first reflection of the first sensing signal and a second reflection of the second sensing signal to obtain sensing information for the target object. In some aspects, 1022 may be performed by the wideband sensing component 198.

In some aspects, the Doppler estimation of the target object may include an estimated velocity of the target object relative to the UE. For example, referring to FIG. 8, the Doppler estimation (at 818) of the target object may include an estimated velocity of the target object relative to the UE 802.

In some aspects, to perform the successive-in-time sensing on the target object (at 1022), the UE may apply a phase compensation to the first signal and the second signal based on the Doppler estimation to obtain phase-compensated signals, and coherently combine the phase-compensated signals to obtain a wideband information having a duration of the second duration. Then, the UE may obtain the sensing information for the target object based on the wideband information. For example, referring to FIG. 6A, the UE may apply a phase compensation to the first signal (e.g., TX1 602) and the second signal (e.g., TX2 604) based on the Doppler estimation to obtain phase-compensated signals, and coherently combine the phase-compensated signals to obtain a wideband information (e.g., TX4 620) having a duration of the second duration (e.g., one symbol). Then, the UE may obtain the sensing information for the target object based on the wideband information (e.g., TX4 620).

In some aspects, the sensing information of the target object may include one or more of: the distance of the target object from the UE, the estimated velocity of the target object relative to the UE, or the angular position of the target object relative to the UE. For example, referring to FIG. 8, the sensing information (at 830) of the target object may include one or more of: the distance of the target object from the UE 802, the estimated velocity of the target object relative to the UE 802, or the angular position of the target object relative to the UE 802.

In some aspects, the wideband information may be based on a wide frequency band encompassing the first frequency band and the second frequency band. For example, referring to FIG. 6A, the wideband information (e.g., TX4 620) may be based on a wide frequency band encompassing the first frequency band (e.g., CC1 612) and the second frequency band (e.g., CC2 614 and CC3 616).

In some aspects, the first duration may be a first number of symbols, and the second duration may be a second number of symbols. The first number of symbols may be based on the CPI associated with a velocity resolution for the target object, and the second number of symbols may be based on an integration gain for the sensing information of the target object. For example, referring to FIG. 6A, the first duration may be a first number of symbols (e.g., three symbols for TX1 602), and the second duration may be a second number of symbols (e.g., one symbol for TX2 604).

In some aspects, at 1002, the UE may transmit, to a network entity, a resource request for sensing the target object. The resource request may include the CPI and the number of symbols for sensing the target object, and the CPI may be indicated in a unit of symbols. For example, referring to FIG. 8, the UE 802 may transmit, at 806, a resource request for sensing a target object to the base station 804. In some aspects, 1002 may be performed by the wideband sensing component 198.

In some aspects, at 1006, the UE may transmit, to the network entity, a feasibility indicator. The feasibility indicator may indicate the feasibility of performing the successive-in-time sensing on the target object, and may be based on an estimated total sensing time of the target object. The network entity may be a base station, or a component of a base station, in the access network of FIG. 1 or a core network component (e.g., base station 102, 310, 804; or the network entity 1302 in the hardware implementation of FIG. 13). For example, referring to FIG. 8, at 810, the UE 802 may transmit a feasibility indicator to the base station 804. The feasibility indicator may indicate the UE's feasibility of performing the successive-in-time sensing on the target object. In some aspects, 1006 may be performed by the wideband sensing component 198.

In some aspects, the first sensing signal may be transmitted periodically based on a periodicity, and, in some aspects, at 1008, the UE may receive a configuration of the periodicity. The first resources may be configured via an RRC message or DCI. For example, referring to FIG. 7, the first sensing signal may be transmitted periodically (e.g., at 702) based on a periodicity. Referring to FIG. 8, the UE 802 may receive, at 814, a configuration of the periodicity. In some aspects, 1008 may be performed by the wideband sensing component 198.

In some aspects, at 1004, the UE may indicate, to the network entity, via an RRC message or UCI, one or more of: the periodicity, the CPI, or the first number of symbols. For example, referring to FIG. 8, at 808, the UE may indicate, to the network entity (base station 804), via an RRC message or UCI, one or more of: the periodicity, the CPI, or the first number of symbols. In some aspects, 1004 may be performed by the wideband sensing component 198.

In some aspects, one or more of the periodicity, the CPI, or the first number of symbols is preconfigured.

In some aspects, at 1016, the UE may transmit a request for using the second sensing signal to the network entity. The request for using the second sensing signal may further indicate one or more of: the second duration for the second sensing signal, or the maximum time gap between the first sensing signal and the second sensing signal. For example, referring to FIG. 8, at 8 22, the UE 802 may transmit a request for using the second sensing signal to the network entity (base station 804). Referring to FIG. 7, the UE may transmit, through UCI 710, a request for using the second sensing signal. In some aspects, 1016 may be performed by the wideband sensing component 198.

In some aspects, the request for transmitting the second sensing signal may be based on an estimated velocity of the target object based on the first sensing signal. For example, referring to FIG. 8, the request (at 822) for transmitting the second sensing signal may be based on an estimated velocity of the target object based on the first sensing signal (transmitted at 816).

In some aspects, the second sensing signal may be transmitted periodically, and, in some aspects, at 1018, the UE may request, via an RRC message or UCI, the allocation of second resources periodically. For example, referring to FIG. 7, the second sensing signal may be transmitted periodically (e.g., at 704, 706). Referring to FIG. 8, at 824, the UE 802 may request the allocation of second resources periodically. In some aspects, 1018 may be performed by the wideband sensing component 198.

In some aspects, at 1024, the UE may terminate the allocation of the second resources in response to a termination timer expired. For example, referring to FIG. 8, at 832, the UE 802 may terminate the allocation of the second resources in response to a termination timer expired. In some aspects, 1024 may be performed by the wideband sensing component 198.

In some aspects, at 1026, the UE may indicate, to the network entity, via an RRC message or UCI, a termination request for terminating the allocation of the second resources. Upon receiving the termination request, the network entity may terminate the allocation of the second resources. For example, referring to FIGS. 7 and 8, the UE 802 may indicate, at 834, to the network entity (base station 804), via an RRC message or UCI, a termination request for terminating the allocation of the second resources (e.g., 704 and 706). Upon receiving the termination request, the network entity (base station 804) may terminate, at 836, the allocation of the second resources (e.g., 704 and 706). In some aspects, 1026 may be performed by the wideband sensing component 198.

In some aspects, at 1014, the UE may transmit to the network entity a capability indicator for maintaining phase coherence for the successive-in-time sensing on the target object. The capability indicator may include one or more of: the minimum time gap between the first sensing signal and the second sensing signal (e.g., between 1010 and 1020), or the maximum gap between the first frequency band and the second frequency band. For example, referring to FIG. 8, the UE 802 may transmit, at 810, to the network entity (base station 804) a capability indicator for maintaining phase coherence for the successive-in-time sensing on the target object. Referring to FIG. 6B, the capability indicator may include one or more of: the minimum time gap between the first sensing signal and the second sensing signal (e.g., the minimum value of the time gap 670) or the maximum gap between the first frequency band and the second frequency band (e.g., the maximum value of the frequency gap 680). In some aspects, 1014 may be performed by the wideband sensing component 198.

In some aspects, the first sensing signal may be transmitted over a first CC, and the second sensing signal may be transmitted over a second CC different from the first CC. For example, referring to FIG. 6A, the first sensing signal (e.g., TX1 602) may be transmitted over a first CC (e.g., CC1 612), and the second sensing signal (e.g., TX2 604) may be transmitted over a second CC (e.g., CC2 614) different from the first CC (e.g., CC1 612).

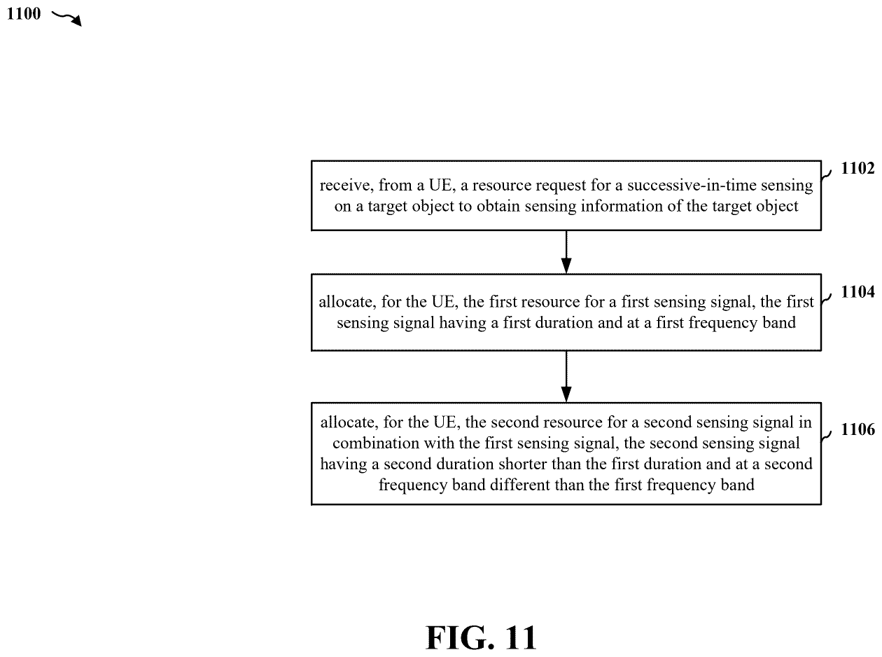

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). The method offers a significant improvement in the effective and efficient usage of UE in RF sensing. The method maintains phase coherence despite high target velocities and ensures an accurate range estimate in RF sensing. Hence, it enhances the reliability and performance of wireless communication.

As shown in FIG. 11, at 1102, the network entity may receive from a UE a resource request for a successive-in-time sensing on a target object to obtain sensing information of the target object. The UE may be the UE 104, 350, 802, or the apparatus 1304 in the hardware implementation of FIG. 13. FIGS. 6A, 6B, 7, and 8 illustrate various aspects of the steps in connection with flowchart 1100. For example, referring to FIG. 8, at 806, the network entity (base station 804) may receive from a UE 802 a resource request for a successive-in-time sensing on a target object to obtain sensing information of the target object. In some aspects, 1102 may be performed by the wideband sensing component 199.

At 1104, the network entity may allocate, for the UE, the first resource for a first sensing signal. The first sensing signal may have a first duration and may be at a first frequency band. For example, referring to FIG. 8, at 812, the network entity (base station 804) may allocate, for the UE 802, the first resource for a first sensing signal. Referring to FIG. 6A, the first sensing signal (e.g., TX1 602) may have a first duration (e.g., three symbols) and may be at a first frequency band (e.g., CC1 612). In some aspects, 1104 may be performed by the wideband sensing component 199.

At 1106, the network entity may allocate, for the UE, the second resource for a second sensing signal in combination with the first sensing signal. The second sensing signal may have a second duration shorter than the first duration and may be at a second frequency band different than the first frequency band. For example, referring to FIG. 8, at 826, the network entity (base station 804) may allocate, for the UE 802, the second resource for a second sensing signal in combination with the first sensing signal. Referring to FIG. 6A, the second sensing signal (e.g., TX2 604) may have a second duration (e.g., one symbol) shorter than the first duration (e.g., three symbols) and may be at a second frequency band (e.g., CC2 614) different than the first frequency band (e.g., CC1 612). In some aspects, 1106 may be performed by the wideband sensing component 199.

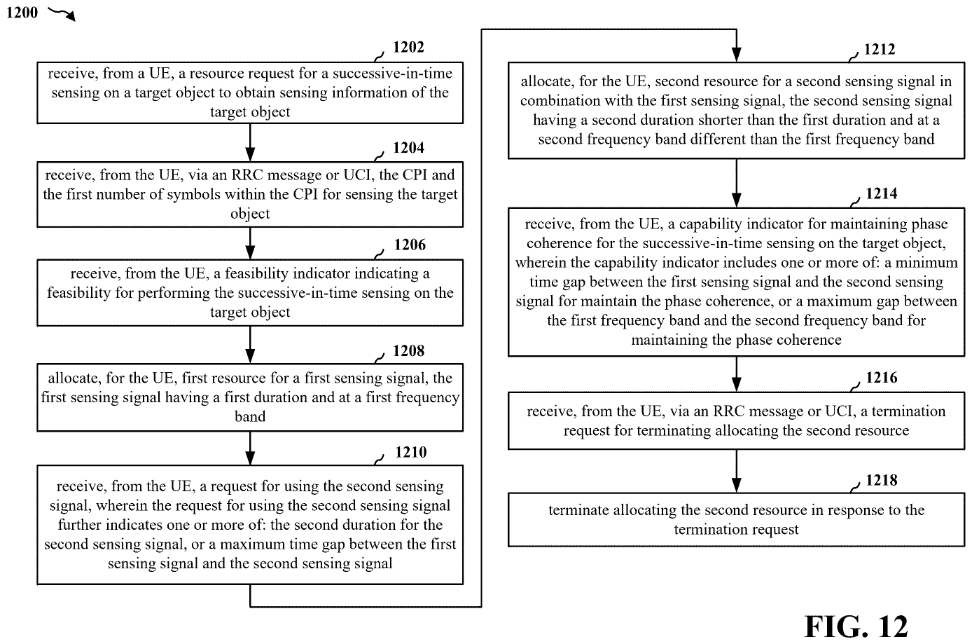

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). The method offers a significant improvement in the effective and efficient usage of UE in RF sensing. The method maintains phase coherence despite high target velocities and ensures an accurate range estimate in RF sensing. Hence, it enhances the reliability and performance of wireless communication.

As shown in FIG. 12, at 1202, the network entity may receive from a UE a resource request for a successive-in-time sensing on a target object to obtain sensing information of the target object. The UE may be the UE 104, 350, 802, or the apparatus 1304 in the hardware implementation of FIG. 13. FIGS. 6A, 6B, 7, and 8 illustrate various aspects of the steps in connection with flowchart 1200. For example, referring to FIG. 8, at 806, the network entity (base station 804) may receive from a UE 802 a resource request for a successive-in-time sensing on a target object to obtain sensing information of the target object. In some aspects, 1202 may be performed by the wideband sensing component 199.

At 1208, the network entity may allocate, for the UE, the first resource for a first sensing signal. The first sensing signal may have a first duration and may be at a first frequency band. For example, referring to FIG. 8, at 812, the network entity (base station 804) may allocate, for the UE 802, the first resource for a first sensing signal. Referring to FIG. 6A, the first sensing signal (e.g., TX1 602) may have a first duration (e.g., three symbols) and may be at a first frequency band (e.g., CC1 612). In some aspects, 1208 may be performed by the wideband sensing component 199.

At 1212, the network entity may allocate, for the UE, the second resource for a second sensing signal in combination with the first sensing signal. The second sensing signal may have a second duration shorter than the first duration and may be at a second frequency band different than the first frequency band. For example, referring to FIG. 8, at 826, the network entity (base station 804) may allocate, for the UE 802, the second resource for a second sensing signal in combination with the first sensing signal. Referring to FIG. 6A, the second sensing signal (e.g., TX2 604) may have a second duration (e.g., one symbol) shorter than the first duration (e.g., three symbols) and may be at a second frequency band (e.g., CC2 614) different than the first frequency band (e.g., CC1 612). In some aspects, 1212 may be performed by the wideband sensing component 199.

In some aspects, the sensing information of the target object may include one or more of: the distance of the target object from the UE, the estimated velocity of the target object relative to the UE, or the angular position of the target object relative to the UE. For example, referring to FIG. 8, the sensing information (at 830) of the target object may include one or more of: the distance of the target object from the UE 802, the estimated velocity of the target object relative to the UE 802, or the angular position of the target object relative to the UE 802.

In some aspects, the first duration may be first number of symbols, and the second duration may be the second number of symbols. The first number of symbols may be based on the CPI associated with a velocity resolution for the target object, and the second number of symbols may be based on an integration gain for the sensing information of the target object. For example, referring to FIG. 6A, the first duration may be a first number of symbols (e.g., three symbols for TX1 602), and the second duration may be a second number of symbols (e.g., one symbol for TX2 604).

In some aspects, at 1206, the network entity may receive, from the UE, a feasibility indicator. The feasibility indicator may indicate the feasibility for performing the successive-in-time sensing on the target object, and the feasibility may be based on an estimated total sensing time of the target object. For example, referring to FIG. 8, at 810, the network entity (base station 804) may receive, from the UE 802, a feasibility indicator. The feasibility indicator may indicate the feasibility for performing the successive-in-time sensing on the target object, and the feasibility may be based on an estimated total sensing time of the target object. In some aspects, 1206 may be performed by the wideband sensing component 199.

In some aspects, to allocate the first resource for the first sensing signal (at 1208), the network entity may allocate the first resource for the first sensing signal transmitted periodically at a periodicity. The first resource may be configured via RRC or DCI, and the periodicity of the first sensing signal may be preconfigured or indicated by the UE. For example, referring to FIG. 7, the network entity may allocate the first resource (e.g., sensing resources 702) for the first sensing signal transmitted periodically at a periodicity.

In some aspects, at 1204, the network entity may receive, from the UE, via an RRC message or UCI, the CPI and the first number of symbols within the CPI for sensing the target object. For example, referring to FIG. 8, at 808, the network entity (base station 804) may receive, from the UE 802, via an RRC message or UCI, the CPI and the first number of symbols within the CPI for sensing the target object. In some aspects, 1204 may be performed by the wideband sensing component 199.

In some aspects, at 1210, the network entity may receive, from the UE, a request for using the second sensing signal. The request for using the second sensing signal may further indicate one or more of: the second duration for the second sensing signal, or the maximum time gap between the first sensing signal and the second sensing signal. For example, referring to FIG. 8, at 822, the network entity (base station 804) may receive, from the UE 802, a request for using the second sensing signal. Referring to FIG. 6B, the request for using the second sensing signal may further indicate one or more of: the second duration (e.g., one symbol) for the second sensing signal (e.g., TX2 654), or the maximum time gap between the first sensing signal and the second sensing signal (e.g., the maximum value of the time gap 670). In some aspects, 1210 may be performed by the wideband sensing component 199.

In some aspects, to allocate the second resource for the second sensing signal (at 1212), the network entity may allocate the second resource for the second sensing signal transmitted periodically. For example, referring to FIG. 7, the network entity may allocate the second resource (e.g., sensing resources 704 and 706) for the second sensing signal transmitted periodically.

In some aspects, at 1216, the network entity may receive, from the UE, via an RRC message or UCI, a termination request for terminating allocating the second resource, and, at 1218, terminate allocating the second resource in response to the termination request. For example, referring to FIG. 8, the network entity (base station 804) may receive, at 834, from the UE 802, via an RRC message or UCI, a termination request for terminating allocating the second resource, and, at 836, the network entity (base station 804) may terminate allocating the second resource in response to the termination request. In some aspects, 1216 and 1218 may each be performed by the wideband sensing component 199.

In some aspects, at 1214, the network entity may receive, from the UE, a capability indicator for maintaining phase coherence for the successive-in-time sensing on the target object. The capability indicator may include one or more of: the minimum time gap between the first sensing signal and the second sensing signal for maintaining the phase coherence, or the maximum gap between the first frequency band and the second frequency band for maintaining the phase coherence. For example, referring to FIG. 8, at 810, the network entity (base station _f1_04) may receive, from the UE 802, a capability indicator for maintaining phase coherence for the successive-in-time sensing on the target object. Referring to FIG. 6B, the capability indicator may include one or more of: the minimum time gap (e.g., the minimum value of the time gap 670) between the first sensing signal (e.g., TX1 652) and the second sensing signal (e.g., TX2 654) for maintaining the phase coherence, or the maximum gap (e.g., the maximum value of the frequency gap 680) between the first frequency band (e.g., CC1 662) and the second frequency band (e.g., CC2 664) for maintaining the phase coherence. In some aspects, 1214 may be performed by the wideband sensing component 199.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359.

In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the component 198 may be configured to transmit a first sensing signal having a first duration and at a first frequency band; obtain a Doppler estimation of a target object based on a reflection of the first sensing signal; transmit a second sensing signal having a second duration shorter than the first duration and at a second frequency band different than the first frequency band; and perform a successive-in-time sensing, based on the Doppler estimation and a combination of the first reflection of the first sensing signal and a second reflection of the second sensing signal to obtain sensing information for the target object. The component 198 may be further configured to perform any of the aspects described in connection with the flowcharts in FIG. 9 and FIG. 10, and/or performed by the UE 802 in FIG. 8. The component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, includes means for transmitting a first sensing signal having a first duration and at a first frequency band, means for obtaining a Doppler estimation of a target object based on a reflection of the first sensing signal, means for transmitting a second sensing signal having a second duration shorter than the first duration and at a second frequency band different than the first frequency band, and means for performing a successive-in-time sensing, based on the Doppler estimation and a combination of the first reflection of the first sensing signal and a second reflection of the second sensing signal to obtain sensing information for the target object. The apparatus 1304 may further include means for performing any of the aspects described in connection with the flowcharts in FIG. 9 and FIG. 10, and/or aspects performed by the UE 802 in FIG. 8. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

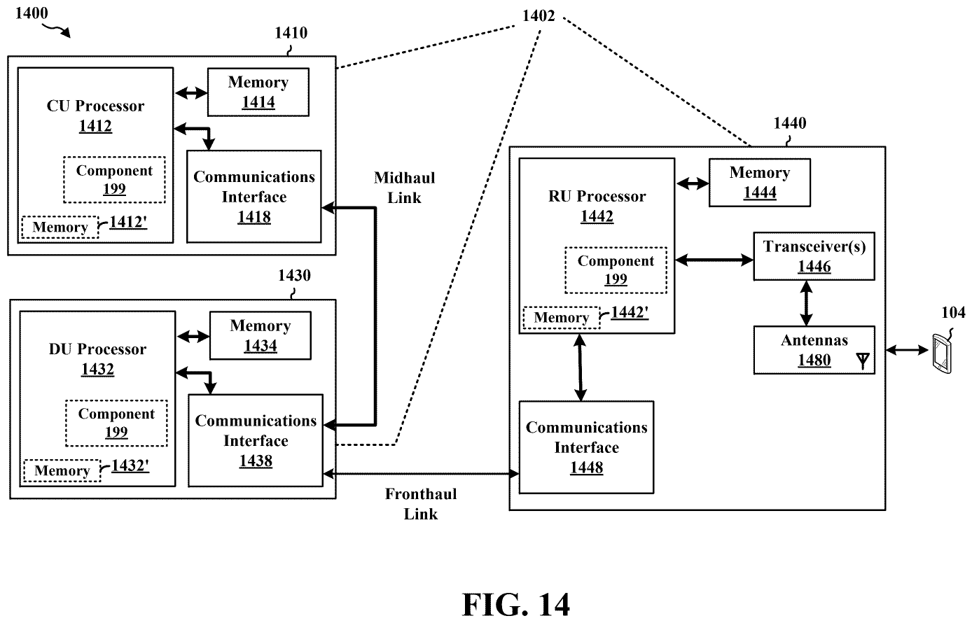

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, a resource request for a successive-in-time sensing on a target object to obtain sensing information of the target object; allocate, for the UE, first resource for a first sensing signal, the first sensing signal having a first duration and at a first frequency band; and allocate, for the UE, second resource for a second sensing signal in combination with the first sensing signal, the second sensing signal having a second duration shorter than the first duration and at a second frequency band different than the first frequency band. The component 199 may be further configured to perform any of the aspects described in connection with the flowcharts in FIG. 11 and FIG. 12, and/or performed by the base station 804 in FIG. 8. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 includes means for receiving, from a UE, a resource request for a successive-in-time sensing on a target object to obtain sensing information of the target object, means for allocating, for the UE, first resource for a first sensing signal, the first sensing signal having a first duration and at a first frequency band, and means for allocating, for the UE, second resource for a second sensing signal in combination with the first sensing signal, the second sensing signal having a second duration shorter than the first duration and at a second frequency band different than the first frequency band. The network entity 1402 may further include means for performing any of the aspects described in connection with the flowcharts in FIG. 11 and FIG. 12, and/or aspects performed by the base station 804 in FIG. 8. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include transmitting a first sensing signal having a first duration and at a first frequency band; obtaining a Doppler estimation of a target object based on a reflection of the first sensing signal; transmitting a second sensing signal having a second duration shorter than the first duration and at a second frequency band different than the first frequency band; and performing a successive-in-time sensing, based on the Doppler estimation and a combination of the first reflection of the first sensing signal and a second reflection of the second sensing signal to obtain sensing information for the target object. The method offers a significant improvement in the effective and efficient usage of UE in RF sensing. The method maintains phase coherence despite high target velocities and ensures an accurate range estimate in RF sensing. Hence, it enhances the reliability and performance of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include transmitting a first sensing signal having a first duration and at a first frequency band; obtaining a Doppler estimation of a target object based on a reflection of the first sensing signal; transmitting a second sensing signal having a second duration shorter than the first duration and at a second frequency band different than the first frequency band; and performing a successive-in-time sensing, based on the Doppler estimation and a combination of the first reflection of the first sensing signal and a second reflection of the second sensing signal to obtain sensing information for the target object.

Aspect 2 is the method of aspect 1, where the Doppler estimation of the target object may include an estimated velocity of the target object relative to the UE.

Aspect 3 is the method of any of aspects 1 to 2, where performing the successive-in-time sensing on the target object may include: applying a phase compensation to the first signal and the second signal based on the Doppler estimation to obtain phase-compensated signals; coherently combining the phase-compensated signals to obtain a wideband information having a duration of the second duration; and obtaining the sensing information for the target object based on the wideband information.

Aspect 4 is the method of aspect 3, where the sensing information of the target object may include one or more of: the distance of the target object from the UE, the estimated velocity of the target object relative to the UE, or the angular position of the target object relative to the UE.

Aspect 5 is the method of aspect 3, where the wideband information may be based on a wide frequency band encompassing the first frequency band and the second frequency band.

Aspect 6 is the method of aspect 3, where the first duration may be the first number of symbols, the second duration may be the second number of symbols. The first number of symbols may be based on a coherent processing interval (CPI) associated with a velocity resolution for the target object, and the second number of symbols may be based on an integration gain for the sensing information of the target object.

Aspect 7 is the method of aspect 6, where the method may further include: transmitting, to a network entity, a resource request for sensing the target object. The resource request may include the CPI and a number of symbols for sensing the target object, and the CPI may be indicated in a unit of symbols.

Aspect 8 is the method of aspect 7, where the method may further include: prior to transmitting the resource request, transmitting, to the network entity, a feasibility indicator indicating a feasibility of performing the successive-in-time sensing on the target object. The feasibility may be based on an estimated total sensing time of the target object.

Aspect 9 is the method of aspect 7, where the first sensing signal may be transmitted periodically at a periodicity, and the method may further include: configuring first resources periodically at the periodicity. The first resources may be configured via Radio Resource Control (RRC) or downlink control information (DCI).

Aspect 10 is the method of aspect 9, where the method may further include: indicating, to the network entity, via an RRC message or Uplink Control Information (UCI), one or more of: the periodicity, the CPI, or the first number of symbols.

Aspect 11 is the method of aspect 9, where one or more of: the periodicity, the CPI, or the first number of symbols is preconfigured.

Aspect 12 is the method of aspect 9, where the method may further include: transmitting a request for using the second sensing signal, and the request for using the second sensing signal may further indicate one or more of: the second duration for the second sensing signal, or the maximum time gap between the first sensing signal and the second sensing signal.

Aspect 13 is the method of aspect 12, where the request for transmitting the second sensing signal may be based on an estimated velocity of the target object based on the first sensing signal.

Aspect 14 is the method of aspect 9, where the second sensing signal may be transmitted periodically, and the method may further include: requesting, via an RRC message or Uplink Control Information (UCI), an allocation of second resources periodically.

Aspect 15 is the method of aspect 14, where the method may further include: terminating, in response to a termination timer expired, the allocation of the second resources.

Aspect 16 is the method of aspect 14, where the method may further include: indicating, to the network entity, via an RRC message or UCI, a termination request for terminating the allocation of the second resources to cause the network entity to terminate the allocation of the second resources.

Aspect 17 is the method of any of aspects 1 to 7, where the method may further include: transmitting, to the network entity, a capability indicator for maintaining phase coherence for the successive-in-time sensing on the target object. The capability indicator may include one or more of: the minimum time gap between the first sensing signal and the second sensing signal, or the maximum gap between the first frequency band and the second frequency band.

Aspect 18 is the method of any of aspects 1 to 7, where the first sensing signal may be transmitted over a first component carrier (CC), and the second sensing signal may be transmitted over a second CC different from the first CC.

Aspect 19 is an apparatus for wireless communication at a UE, including: at least one memory; and at least one processor coupled to the at least one memory and, based at least in part on information stored in the at least one memory, the at least one processor, individually or in any combination, is configured to perform the method of any of aspects 1-18.

Aspect 20 is an apparatus for wireless communication at a UE, including: at least one memory; and at least one processor coupled to the at least one memory, and the at least one processor, individually or in any combination, is configured to perform the method of any of aspects 1-18.

Aspect 21 is the apparatus of aspect 19 or 20, further including at least one of a transceiver or an antenna coupled to the at least one processor and configured to transmit the first sensing signal.

Aspect 22 is an apparatus for wireless communication at a UE, including: one or more memories; and one or more processors coupled to the one or more memories and, based at least in part on information stored in the one or more memories, the one or more processors, individually or in any combination, are configured to perform the method of any of aspects 1-18.

Aspect 23 is an apparatus for wireless communication including means for implementing the method of any of aspects 1-18.

Aspect 24 is a computer-readable medium (e.g., a non-transitory computer-readable medium) storing computer executable code, where the code when executed by at least one processor causes the at least one processor to, individually or in any combination, implement the method of any of aspects 1-18.

Aspect 25 is a method of wireless communication at a network entity. The method may include: receiving, from a user equipment (UE), a resource request for a successive-in-time sensing on a target object to obtain sensing information of the target object; allocating, for the UE, first resource for a first sensing signal, the first sensing signal having a first duration and at a first frequency band; and allocating, for the UE, second resource for a second sensing signal in combination with the first sensing signal, the second sensing signal having a second duration shorter than the first duration and at a second frequency band different than the first frequency band.

Aspect 26 is the method of aspect 25, where the sensing information of the target object may include one or more of: the distance of the target object from the UE, the estimated velocity of the target object relative to the UE, or the angular position of the target object relative to the UE.

Aspect 27 is the method of any of aspects 25 to 26, where the first duration may be the first number of symbols, the second duration may be the second number of symbols. The first number of symbols may be based on a coherent processing interval (CPI) associated with a velocity resolution for the target object, and the second number of symbols may be based on an integration gain for the sensing information of the target object.

Aspect 28 is the method of aspect 27, where the method may further include: prior to receiving the resource request, receiving, from the UE, a feasibility indicator indicating a feasibility for performing the successive-in-time sensing on the target object. The feasibility may be based on an estimated total sensing time of the target object.

Aspect 29 is the method of aspect 27, where allocating the first resource for the first sensing signal may include: allocating the first resource for the first sensing signal transmitted periodically at a periodicity. The first resource may be configured via a Radio Resource Control (RRC) message or downlink control information (DCI), and the periodicity of the first sensing signal may be preconfigured or indicated by the UE.

Aspect 30 is the method of aspect 29, where the method may further include: receiving, from the UE, via an RRC message or Uplink Control Information (UCI), the CPI and the first number of symbols within the CPI for sensing the target object.

Aspect 31 is the method of any of aspects 25 to 29, where the method may further include: receiving, from the UE, a request for using the second sensing signal. The request for using the second sensing signal may further indicate one or more of: the second duration for the second sensing signal, or the maximum time gap between the first sensing signal and the second sensing signal.

Aspect 32 is the method of any of aspects 25 to 29, where allocating the second resource for the second sensing signal may include: allocating the second resource for the second sensing signal transmitted periodically.

Aspect 33 is the method of aspect 30, where the method may further include: receiving, from the UE, via an RRC message or Uplink Control Information (UCI), a termination request for terminating allocating the second resource; and terminating allocating the second resource in response to the termination request.

Aspect 34 is the method of any of aspects 27 to 33, where the method may further include: receiving, from the UE, a capability indicator for maintaining phase coherence for the successive-in-time sensing on the target object. The capability indicator may include one or more of: the minimum time gap between the first sensing signal and the second sensing signal for maintaining the phase coherence, or the maximum gap between the first frequency band and the second frequency band for maintaining the phase coherence.

Aspect 35 is an apparatus for wireless communication at a network entity, including: at least one memory; and at least one processor coupled to the at least one memory and, based at least in part on information stored in the at least one memory, the at least one processor, individually or in any combination, is configured to perform the method of any of aspects 25-34.

Aspect 36 is an apparatus for wireless communication at a network entity, including: at least one memory; and at least one processor coupled to the at least one memory, the at least one processor, individually or in any combination, is configured to perform the method of any of aspects 25-34.

Aspect 37 is the apparatus of aspect 35 or 36, further including at least one of a transceiver or an antenna coupled to the at least one processor and configured to receive the resource request.

Aspect 38 is an apparatus for wireless communication at a network entity, including: one or more memories; and one or more processors coupled to the one or more memories and, based at least in part on information stored in the one or more memories, the one or more processors, individually or in any combination, are configured to perform the method of any of aspects 25-34.

Aspect 39 is an apparatus for wireless communication including means for implementing the method of any of aspects 25-34.

Aspect 40 is a computer-readable medium (e.g., a non-transitory computer-readable medium) storing computer executable code, where the code when executed by at least one processor causes the at least one processor to, individually or in any combination, implement the method of any of aspects 25-34.

1. An apparatus of wireless communication at a user equipment (UE), comprising:
at least one memory; and
at least one processor coupled to the at least one memory and, based at least in part on information stored in the at least one memory, the at least one processor, individually or in any combination, is configured to:
transmit a first sensing signal having a first duration and at a first frequency band;
obtain a Doppler estimation of a target object based on a first reflection of the first sensing signal;
transmit a second sensing signal having a second duration shorter than the first duration and at a second frequency band different than the first frequency band; and
perform a successive-in-time sensing based on the Doppler estimation and a combination of the first reflection of the first sensing signal and a second reflection of the second sensing signal to obtain sensing information for the target object.

2. (canceled)

3. The apparatus of claim 1, wherein, to perform the successive-in-time sensing on the target object, the at least one processor, individually or in any combination, is configured to:
apply a phase compensation to the first sensing signal and the second sensing signal based on the Doppler estimation to obtain phase-compensated signals;
coherently combine the phase-compensated signals to obtain a wideband information having a duration of the second duration; and
obtain the sensing information for the target object based on the wideband information.

4. (canceled)

5. (canceled)

6. The apparatus of claim 3, wherein the first duration is a first number of symbols, the second duration is a second number of symbols, and wherein the first number of symbols is based on a coherent processing interval (CPI) associated with a velocity resolution for the target object, and the second number of symbols is based on an integration gain for the sensing information of the target object.

7. The apparatus of claim 6, wherein the at least one processor, individually or in any combination, is further configured to:
transmit, to a network entity, a resource request for sensing the target object, wherein the resource request includes the CPI and a number of symbols for sensing the target object, wherein the CPI is indicated in a unit of symbols.

8. The apparatus of claim 7, wherein the at least one processor, individually or in any combination, is further configured to, prior to being configured to transmit the resource request:
transmit, to the network entity, a feasibility indicator indicating a feasibility of performing the successive-in-time sensing on the target object, wherein the feasibility is based on an estimated total sensing time of the target object.

9. The apparatus of claim 7, wherein the first sensing signal is transmitted periodically based on a periodicity, and wherein the at least one processor, individually or in any combination, is further configured to:
receive a configuration of the periodicity via a Radio Resource Control (RRC) message or downlink control information (DCI).

10. The apparatus of claim 9, wherein the at least one processor, individually or in any combination, is further configured to:
indicate, to the network entity, via an RRC message or Uplink Control Information (UCI), one or more of:
the periodicity,
the CPI, or
the first number of symbols.

11. (canceled)

12. The apparatus of claim 9, wherein the at least one processor, individually or in any combination, is further configured to:
transmit a request for using the second sensing signal, wherein the request for using the second sensing signal further indicates one or more of:
the second duration for the second sensing signal, or
a maximum time gap between the first sensing signal and the second sensing signal.

13. The apparatus of claim 12, wherein the request for transmitting the second sensing signal is based on an estimated velocity of the target object based on the first sensing signal.

14. The apparatus of claim 9, wherein the second sensing signal is transmitted periodically, and wherein the at least one processor, individually or in any combination, is further configured to:
request, via an RRC message or Uplink Control Information (UCI), an allocation of second resources periodically.

15. The apparatus of claim 14, wherein the at least one processor, individually or in any combination, is further configured to:
terminate, in response to a termination timer expired, the allocation of the second resources.

16. The apparatus of claim 14, wherein the at least one processor, individually or in any combination, is further configured to:
indicate, to the network entity, via an RRC message or the UCI, a termination request for terminating the allocation of the second resources to cause the network entity to terminate the allocation of the second resources.

17. The apparatus of claim 7, wherein the at least one processor, individually or in any combination, is further configured to:
transmit, to the network entity, a capability indicator for maintaining phase coherence for the successive-in-time sensing on the target object, wherein the capability indicator includes one or more of:
a minimum time gap between the first sensing signal and the second sensing signal, or
a maximum gap between the first frequency band and the second frequency band.

18. The apparatus of claim 7, wherein the first sensing signal is transmitted over a first component carrier (CC), and the second sensing signal is transmitted over a second CC different from the first CC.

19. An apparatus of wireless communication at a network entity, comprising:
at least one memory; and
at least one processor coupled to the at least one memory and, based at least in part on information stored in the at least one memory, the at least one processor, individually or in any combination, is configured to:
receive, from a user equipment (UE), a resource request for a successive-in-time sensing on a target object to obtain sensing information of the target object;
allocate, for the UE, first resource for a first sensing signal, the first sensing signal having a first duration and at a first frequency band; and
allocate, for the UE, second resource for a second sensing signal in combination with the first sensing signal, the second sensing signal having a second duration shorter than the first duration and at a second frequency band different than the first frequency band.

20. (canceled)

21. The apparatus of claim 19, wherein the first duration is a first number of symbols, the second duration is a second number of symbols, and wherein the first number of symbols is based on a coherent processing interval (CPI) associated with a velocity resolution for the target object, and the second number of symbols is based on an integration gain for the sensing information of the target object.

22. The apparatus of claim 21, wherein the at least one processor, individually or in any combination, is further configured to: prior to being configured to receive the resource request,
receive, from the UE, a feasibility indicator indicating a feasibility for performing the successive-in-time sensing on the target object, wherein the feasibility is based on an estimated total sensing time of the target object.

23. The apparatus of claim 21, wherein, to allocate the first resource for the first sensing signal, the at least one processor, individually or in any combination, is configured to:
allocate the first resource for the first sensing signal transmitted periodically at a periodicity, and wherein the first resource is configured via a Radio Resource Control (RRC) message or downlink control information (DCI), and the periodicity of the first sensing signal is preconfigured or indicated by the UE.

24. (canceled)

25. (canceled)

26. (canceled)

27. (canceled)

28. The apparatus of claim 21, wherein the at least one processor, individually or in any combination, is further configured to:
receive, from the UE, a capability indicator for maintaining phase coherence for the successive-in-time sensing on the target object, wherein the capability indicator includes one or more of:
a minimum time gap between the first sensing signal and the second sensing signal for maintaining the phase coherence, or
a maximum gap between the first frequency band and the second frequency band for maintaining the phase coherence.

29. A method of wireless communication at a user equipment (UE), comprising:
transmitting a first sensing signal having a first duration and at a first frequency band;
obtaining a Doppler estimation of a target object based on a first reflection of the first sensing signal;
transmitting a second sensing signal having a second duration shorter than the first duration and at a second frequency band different than the first frequency band; and
performing a successive-in-time sensing, based on the Doppler estimation and a combination of the first reflection of the first sensing signal and a second reflection of the second sensing signal to obtain sensing information for the target object.

30. (canceled)
